(19) United States
(12) Patent Application Publication
(10) Pub. No.: US 2026/0250110 A1
(43) Pub. Date: Aug. 27, 2026

(54) HIGH-SPEED RACK-MOUNTED STORAGE ROBOT

(71) Applicant: ZHEJIANG ZHONGYANG AUTOMATED STORAGE TECHNOLOGY CO., LTD., JIAXING (CN)

(72) Inventors: XINAN CHEN, JIAXING (CN); KAISHENG WANG, JIAXING (CN); WEIQIANG WANG, JIAXING (CN); JIADONG XIAO, JIAXING (CN); BIN ZHAO, JIAXING (CN); CHUNLEI ZHANG, JIAXING (CN); TAO LING, JIAXING (CN); QINGGUANG HUANG, JIAXING (CN); CHENGXIAO XIE, JIAXING (CN); YUNZHE WU, JIAXING (CN); JIJING LIU, JIAXING (CN); KAIWEI WANG, JIAXING (CN)

(21) Appl. No.: 19/326,796

(22) Filed: Sep. 12, 2025

(30) Foreign Application Priority Data
Feb. 26, 2025 (CN) 202510216507.9

(51) Int. Cl. B66F 9/07; B65G 1/04; B66F 9/075

(52) U.S. Cl. CPC B66F 9/072; B65G 1/0428; B66F 9/07559

(57) ABSTRACT

The present disclosure relates to the technical field of logistics warehousing, and discloses a high-speed rack-mounted storage robot, which includes vertical columns, loading platforms, and a lifting device. The loading platform is slidably mounted on the vertical column. Two or more groups of the loading platforms are arranged along a vertical direction of the vertical column. A bottom of the vertical column is fixedly installed with the lifting device for driving the loading platform to move vertically. A top and a bottom of the vertical column are both provided with a rail. The vertical column is fixedly installed with two or more groups of driving wheel assemblies for driving the vertical column to slide along the rails. The driving wheel assemblies is slidably connected to the rail. The rails are fixedly connected to a rack. A length of the rails is longer than a length of the rack.

### CROSS-REFERENCE TO RELATED APPLICATION

The present disclosure claims priority to Chinese Patent Application No. 202510216507.9, filed on February 26, 2025, the disclosures of which is incorporated herein by reference in its entirety.

### TECHNICAL FIELD

The present disclosure relates to the technical field of logistics and warehousing, and in particular to a high-speed rack-mounted storage robot.

### BACKGROUND

Stacker cranes are a type of efficient and automated material handling device in the field of logistics and warehousing. The stacker cranes can shuttle back and forth between aisles of three-dimensional warehouses, using forks or telescoping mechanisms to perform storage and retrieval operations on goods on racks. The stacker cranes are generally composed of a traveling mechanism, a lifting mechanism, a fork telescoping mechanism, and an electrical control system, etc., and has characteristics of simple operation, precise positioning, stable operation, a high degree of automation, etc. In modern logistics warehouses, stacker cranes are widely used in various types of high-bay warehouses, which can significantly improve efficiency of storage operations, reduce labor costs, and are one of the important devices for achieving warehouse automation and intelligence. Existing stacker cranes are divided into heavy-duty stacker cranes and light-duty stacker cranes, which are two important types of devices in the field of logistics and warehousing, and have significant differences in structure, function and application scenarios.

The heavy-duty stacker cranes typically have complex manufacturing processes and high-strength structural designs, capable of withstanding heavy loads, and are suitable for places such as large logistics centers and factory warehouses that need to handle heavy goods. This type of stacker crane, during design, will select the type of vertical columns according to the site environment and working conditions, such as double-vertical-column structures to increase stability, ensuring safety and reliability when handling heavy goods. The heavy-duty stacker cranes are usually equipped with advanced control systems to achieve accurate positioning and operation, satisfying scenarios with higher requirements for goods handling efficiency. In contrast, the light-duty stacker cranes have a more lightweight structure and are suitable for high-speed turnover container storage systems. They usually adopt a single-vertical-column or double-vertical-column structure, but the overall weight is lighter, material consumption is less, and operating speed is fast, with high efficiency. The light-duty stacker cranes can satisfy high-frequency and high-efficiency picking demands, and are therefore more suitable for places such as e-commerce warehouses, food warehouses, pharmaceutical warehouses, and other places that need to handle a large number of small goods.

However, in some large warehouses, in order to maximize storage space, racks are often designed to be very high. The light-duty stacker cranes, due to their lightweight design, when moving rapidly to these higher positions, due to their own structural limitations and center of gravity offset, are prone to generate swaying. Such swaying not only affects the stability and accuracy of the stacker crane, but may also cause errors during the goods storage and retrieval process. Furthermore, swaying will also increase the wear and maintenance costs of the stacker crane, reducing its service life. Meanwhile, existing light-duty stacker cranes, due to their relatively high price, if each rack is provided with a light-duty stacker crane for use, storage costs will be greatly increased. Moreover, in some compact warehouses or old warehouses with limited space, due to uneven ground or cramped spaces, the installation and use of traditional stacker cranes are often limited. Traditional stacker cranes need to be installed in positions with with high ground precision to ensure their stability and accuracy. However, in some warehouses with uneven ground or cramped space, this requirement is difficult to meet. Furthermore, traditional stacker cranes also require additional ground space for installation and commissioning, further increasing installation difficulty and costs.

### SUMMARY

(I) Technical problems solved: Aiming at the deficiencies of the prior art, the present disclosure provides a high-speed rack-mounted storage robot, which has the advantages of being able to maintain its own stability during high-speed operation, having a large range for storing and retrieving goods, and not requiring installation on the ground, solving the problems that existing stacker cranes are prone to swaying during high-speed operation, require fixed installation on the ground, and require installation for each group of racks.

(II) Technical solution: In order to achieve the above objectives of maintaining its own stability during high-speed operation, having a large range for storing and retrieving goods, and not requiring installation on the ground, the present disclosure provides the following technical solution: A high-speed rack-mounted storage robot, includes vertical columns, loading platforms, and a lifting device. Two or more groups of the loading platform are slidably mounted on the vertical column, and the loading platform is arranged along a vertical direction of the vertical column. A bottom of the vertical column is fixedly installed with the lifting device that drives the loading platform to move vertically. A top and a bottom of the vertical column are both provided with a rail. The vertical column is fixedly installed with two or more groups of driving wheel assemblies that drive the vertical column to slide along the rails. The driving wheel assemblies are slidably connected to the rails. The rail is fixedly connected to a rack, a length of the rails being greater than a length of the rack.

In some embodiments, both ends of the loading platform are provided with a transmission structure. Between the transmission structure and the lifting device is provided with a transmission chain. The lifting devices at both ends of the vertical column respectively drive two groups of the loading platforms to move up and down independently.

In some embodiments, the loading platform is placed with goods, and the loading platform is provided with clamping plates that are capable of moving along a horizontal direction of the loading platform to load and unload goods.

In some embodiments, two or more groups of the vertical column are provided, and between two or more of the vertical columns is provided with a crossbeam.

In some embodiments, the rack includes support columns, support beams, and shelf panels. A plurality of the support columns are arranged vertically at equal intervals. Two or more of the support beams are fixedly connected between the support columns. Three or more groups of the shelf panels for placing goods are arranged between the support columns. The rails are mounted to the support beams. The rails are further fixedly connected with telescoping mechanisms for controlling forward and backward telescoping movement of the rails. The telescoping mechanisms are fixedly connected to the support beams. The telescoping mechanisms drive the rails and the vertical columns mounted on the rails to move together when the telescoping mechanisms telescope.

In some embodiments, four or more groups of the telescoping mechanisms are provided. An anti-sway push plate for preventing the vertical column from swaying during movement is arranged between the rails at the top and the bottom. Between the anti-sway push plate and the vertical column is provided with the driving wheel assembly. The anti-sway push plate is slidably connected with the shelf panel. Between the shelf panel and the anti-sway push plate is provided with a pneumatic rod. The anti-sway push plate abuts, in a direction perpendicular to a sliding direction of the driving wheel assembly, against the driving wheel assembly.

In some embodiments, between the anti-sway push plate and an abutting surface of the driving wheel assembly is provided with a tensioning pulley. The tensioning pulley is rotationally connected to the driving wheel assembly.

In some embodiments, the rails at both sides of the rack are provided with rotary guide rails,. The rotary guide rails are rotationally connected to the support columns. The rotary guide rails are vertically height-aligned with the rails, and an upper rotary guide rail and a lower rotary guide rail are fixedly connected by a connecting plate. The rotary guide rail is provided with a rotation motor for driving the rotary guide rail to rotate. When the vertical column moves to the rotary guide rail along the rails, the rotary guide rail drives the vertical column to rotate.

In some embodiments, the rotary guide rail is fixedly connected with a rotation shaft. The rotation shaft connects the upper rotary guide rail and the lower rotary guide rail. The rotation shaft is rotationally connected with the support columns, and the rotation shaft is connected to a drive shaft of the rotation motor. The rotation motor is fixedly installed on the support columns of the rack.

In some embodiments, an extension push plate is arranged between the upper rotary guide rail and lower rotary guide rail. The extension push plate is fixedly installed on the connecting plate, and the extension push plate is position-aligned with the anti-sway push plate. The extension push plate is rotationally connected to the support columns.

In some embodiments, a slidable locking block is further arranged inside the rotary guide rail. An elastic trigger structure is arranged between the locking block and the rotary guide rail, and the rail opposite to the locking block is provided with an adsorption block that is capable of attracting the locking block. The adsorption block is fixedly installed inside the rail. The driving wheel assembly is provided with an unlocking block that is capable of attracting the locking block to slide inside the rotary guide rail. The unlocking block and the locking block adopt magnets with opposite magnetic poles, the adsorption block adopt iron. The elastic trigger structure is connected with the rotation shaft. When the elastic trigger structure is compressed, the rotation shaft releases locking, and when the elastic trigger structure is not compressed, the rotation shaft is locked.

(III) Beneficial effects: Compared with the prior art, the present disclosure provides a high-speed rack-mounted storage robot, which has the following beneficial effects: 1, this high-speed rack-mounted storage robot, through the coordinated use of the driving wheel assembly structure, the rail structure, and the loading platform structure, can effectively control its swing amplitude during the movement of the vertical column, and the design of the rails on the rack effectively reduces installation difficulty and installation costs, while also improving installation accuracy. During the goods retrieval process, the dual loading platform design enables independent vertical movement and goods retrieval, greatly improving retrieval efficiency.

2, this high-speed rack-mounted storage robot, through the coordinated use of the rail structure and the telescoping mechanism, only requires installing one group of storage robot between every two racks. This design can not only reduce the number of storage robot installations and lower costs but also effectively increase the usable space between the racks, thereby increasing the operational space between the racks, allowing some transport vehicles to pass between the racks, improving the overall operational efficiency of the warehouse.

3, this high-speed rack-mounted storage robot, through the coordinated use of the rotary guide rails and the rail structure, enables the storage robot to adjust the direction of the loading platform as needed, thereby moving goods from the rack to conveyor belts in different directions, allowing the robot to adapt to different operational requirements and spatial layouts. The robot can complete direction changes without occupying additional space, improving storage and operational efficiency. Moreover, when the storage robot is in dormancy state, the storage robot no longer occupies the linear space between the racks, and the passage space of the warehouse becomes more spacious. Thus, not only are other operations in the warehouse facilitated, such as transport vehicles and personnel passage, but also the space within the warehouse can be utilized more effectively, improving the overall operational efficiency of the warehouse; and through the elastic trigger structure, accidental rotation when the vertical column has not moved onto the rotary guide rails can be effectively avoided, thereby improving equipment safety.

4, this high-speed rack-mounted storage robot, through the coordinated use of the anti-sway push plate and the pneumatic rod, can provide buffering and damping effects when the the vertical column sways, thereby absorbing and dispersing vibration energy, avoiding swaying of the vertical column during operation along the rails, improving the stability of robot operation, ensuring that the loading platform can accurately reach designated positions for goods access, simultaneously reducing impact and wear on the rack and surrounding environment during operation, extending the service life of equipment and the rack, and also reducing noise.

### BRIEF DESCRIPTION OF THE DRAWINGS

FIG. 1 is a front view of the structure of a high-speed rack-mounted storage robot according to the present disclosure.

FIG. 2 is a front view of the structure of a vertical column of the high-speed rack-mounted storage robot according to the present disclosure.

FIG. 3 is a three-dimensional schematic diagram of the structure of a loading platform of the high-speed rack-mounted storage robot according to the present disclosure.

FIG. 4 is a three-dimensional schematic diagram of the structure of the vertical column and a rail of the high-speed rack-mounted storage robot according to the present disclosure.

FIG. 5 is a sectional side view of the structure of the vertical column and the rail structure of the high-speed rack-mounted storage robot according to the present disclosure.

FIG. 6 is a schematic diagram of a telescoping motion of the rail structure according to the present disclosure.

FIG. 7 is a schematic diagram of the rotation of the rotary guide rail structure according to the present disclosure.

FIG. 8 is an enlarged view of the structure shown in a region A in FIG. 5.

FIG. 9 is a schematic diagram of an elastic trigger structure of the high-speed rack-mounted storage robot according to the present disclosure, showing that the elastic trigger structure is not compressed.

FIG. 10 is a schematic diagram of the elastic trigger structure of the high-speed rack-mounted storage robot according to the present disclosure, showing that the elastic trigger structure is compressed.

In the drawings: 100, storage robot; 1, vertical column; 11, lifting device; 12, crossbeam; 13, driving wheel assembly; 14, tensioning pulley; 15, unlocking block; 2, loading platform; 21, transmission structure; 22, clamping plate; 3, rail; 31, telescoping mechanism; 32, adsorption block; 4, rack; 41, support column; 42, support beam; 43, shelf panel; 5, anti-sway push plate; 51, pneumatic rod; 6, rotary guide rail; 61, connecting plate; 62, rotating motor; 63, extension push plate; 64, locking block; 65, elastic trigger structure.

### DETAILED DESCRIPTION

The following will clearly and completely describe the technical solutions in the embodiments of the present disclosure with reference to the accompanying drawings in the embodiments of the present disclosure. Obviously, the described embodiments are merely a part rather than all of the embodiments of the present disclosure. Based on the embodiments of the present disclosure, all other embodiments obtained by those of ordinary skill in the art without creative efforts shall fall within the protection scope of the present disclosure.

### Embodiment 1

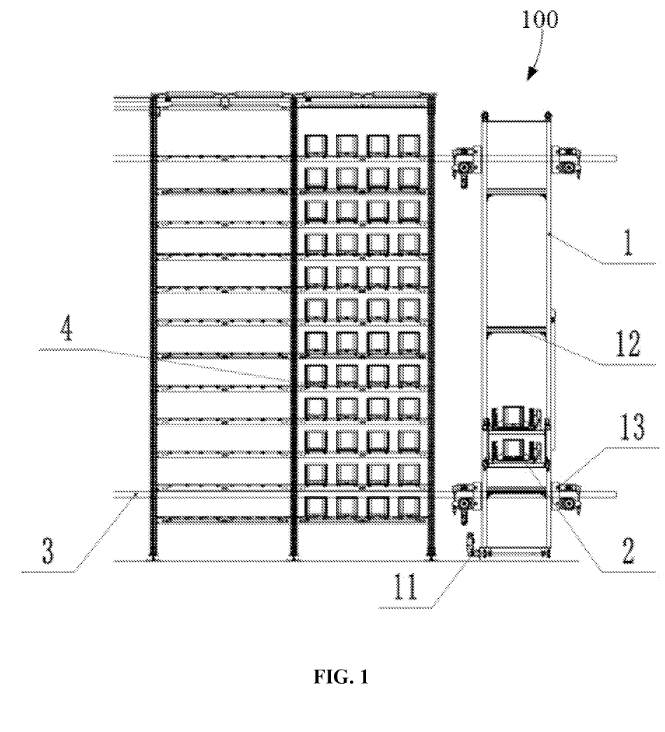

Referring to FIG. 1 to FIG. 3, a high-speed rack-mounted storage robot 100 is provided. The storage robot 100 includes vertical columns 1, loading platforms 2, and lifting devices 11. The loading platform 2 is slidably mounted on the vertical column 1. In the embodiments, two or more groups of the loading platforms 2 are provided along a vertical direction of the vertical column 1. The arrangement of two or more groups of the loading platforms 2 along the vertical direction of the vertical column 1 is mainly for improving the working efficiency of the storage robot 100. Through the design of two or more groups of the loading platforms 2, multiple loading platforms 2 can simultaneously or independently perform goods storage and retrieval operations, thereby greatly improving goods handling speed and efficiency. This design enables the storage robot 100 to complete more tasks in a single trip, reducing waiting time and empty travel distance.

A bottom of the vertical column 1 is fixedly installed with the lifting device 11 that drives the loading platform 2 to move vertically. The lifting device 11 adopts a combination of a motor and a reducer. The bottom of the vertical column 1 is fixedly installed with the lifting device 11 that drives the loading platform 2 to move vertically, in order to achieve precise lifting and lowering movement of the loading platform 2 on the vertical column 1. This design can ensure that the loading platform 2 can accurately reach any level on a rack 4 for goods storage and retrieval operations.

A top and a bottom of the vertical column 1 are both provided with a rail 3. The top and the bottom of the vertical column 1 are both provided with the rail 3, in order to achieve stable sliding and precise positioning of the vertical column 1 on the rack 4. Through the design of the rail 3 at the top and the bottom, it can ensure that the vertical column 1 can move smoothly in a horizontal direction and can precisely stop at any position.

The vertical column 1 is fixedly installed with two or more groups of driving wheel assemblies 13 that drive the vertical column 1 to slide along the rails 3. The driving wheel assembly 13 is slidably connected to the rail 3. The vertical column 1 is fixedly installed with two or more groups of the driving wheel assemblies 13 that drive the vertical column 1 to slide along the rail 3, in order to improve the stability and load-bearing capacity of the vertical column 1 on the rail 3. Through the design of multiple groups of the driving wheel assemblies 13, it can distribute the weight and force of the vertical column 1 during movement, enabling the vertical column 1 to move more steadily and withstand greater loads.

The rail 3 is fixedly connected to the rack 4. A length of the rail 3 is longer than a length of the rack 4. The length of the rail 3 is longer than the length of the rack 4, in order to improve the working range and flexibility of the storage robot 100. By designing a longer rail 3, the storage robot 100 can move and wait in areas outside the rack 4.

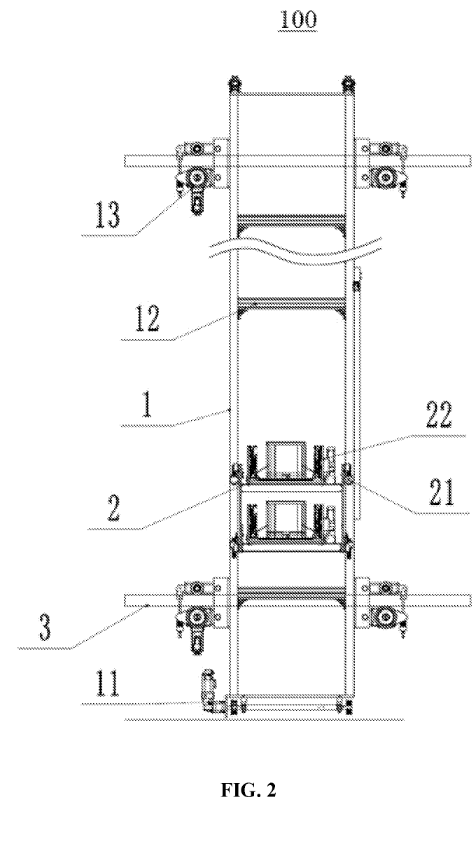

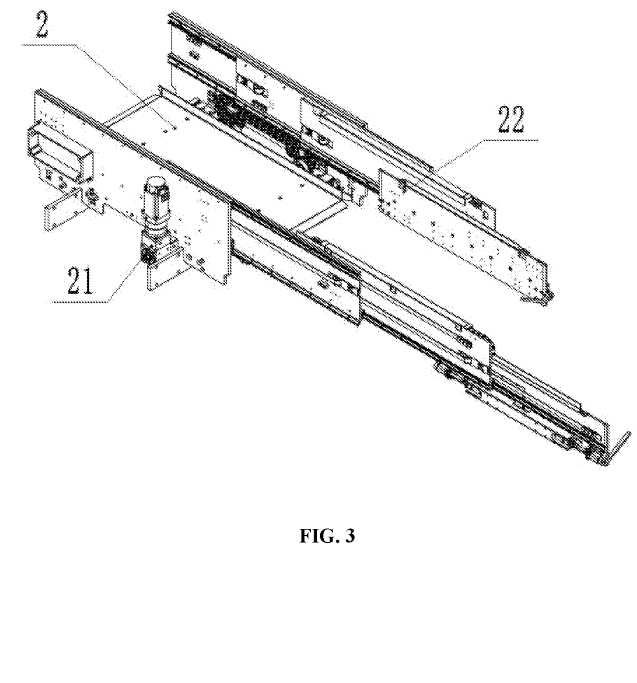

Please refer to FIG. 2 and FIG. 3, both ends of the loading platform 2 are provided with a transmission structure 21. The transmission structure 21 adopts chain drive. Between the transmission structure 21 and the lifting device 11 is provided with a transmission chain. The transmission structure 21 can ensure that the loading platform 2 can move steadily and accurately along the vertical direction of the vertical column 1. The transmission structure 21 can transmit power from the lifting device 11. The transmission chain can effectively reduce friction and vibration during movement, ensuring that the loading platform 2 can stably lift and lower, and precisely reach the required height.

The lifting devices 11 at both sides of the vertical column 1 respectively drive two groups of the loading platforms 2 to move up and down independently. Through independently driving two groups of the loading platforms 2, simultaneous or alternate goods storage and retrieval operations are achieved, thereby greatly improving the work efficiency of the storage robot 100. Furthermore, independent driving can also enable the storage robot 100 to flexibly adjust the height of loading platform 2 when facing goods of different heights, to adapt to different storage and retrieval requirements. The loading platform 2 is placed with goods, and the loading platform 2 is provided with clamping plates 22 that can move along a horizontal direction of loading platform 2 to load and unload goods. The clamping plates 22 can precisely clamp and place goods. The clamping plate 22 can also be adjusted according to the shape and size of the goods, to adapt to different types of goods. Through the clamping plate 22 moving along the horizontal direction of the loading platform 2, loading and unloading operations of goods can be easily achieved.

In the embodiment, two or more of the vertical columns 1 are provided, and between the two or more vertical columns 1 is provided a crossbeam 12. This can improve the stability and load capacity of the storage robot 100. Through increasing the number of the vertical columns 1 and providing the crossbeam 12, a more stable structural framework can be formed, thereby effectively resisting various forces and vibrations generated during the movement of the storage robot 100.

### Embodiment 2

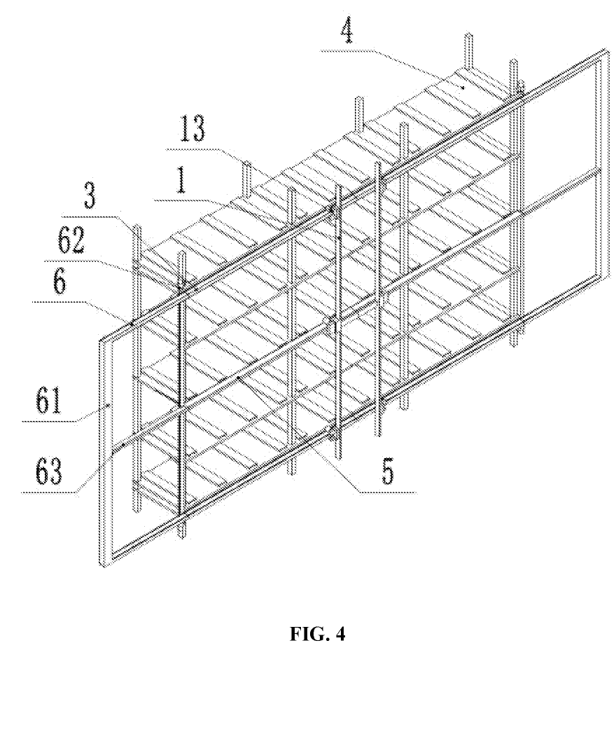

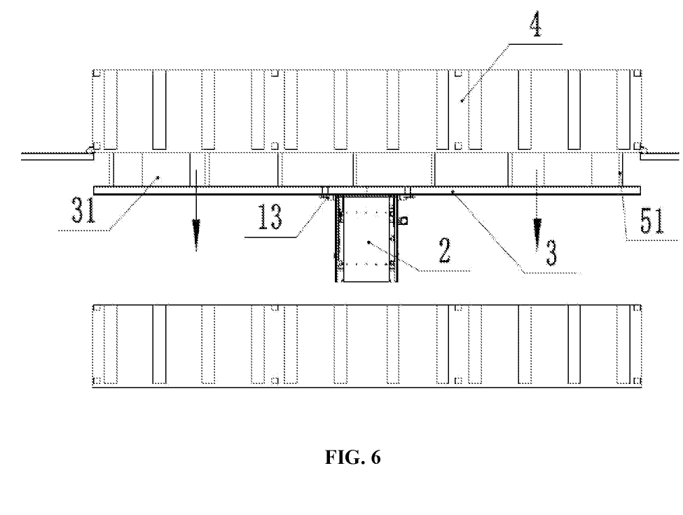

Please refer to FIG. 4 to FIG. 6, the rack 4 includes support columns 41, support beams 42, and shelf panels 43. A plurality of the support columns 41 are arranged vertically at equal intervals. Designing a plurality of the support columns 41 to be arranged vertically at equal intervals is mainly to ensure the stability and load-bearing capacity of the rack 4. The support columns 41, as the main load-bearing structure of the rack 4, their quantity and layout have a crucial impact on the overall performance of the rack 4. Equally spaced support columns 41 can uniformly distribute the load of the rack 4, preventing deformation of the rack 4 due to uneven load distribution.

Two or more of the support beams 42 are fixedly connected between the support columns 41. Designing two or more of the support beams 42 to be fixedly connected between the support columns 41 is mainly to enhance the rigidity and stability of the rack 4. The support beams 42, as horizontal members connecting the support columns 41, can effectively connect each support column 41 into an integral whole, thereby improving the overall bending resistance and torsional resistance capabilities of the rack 4. Furthermore, two or more of the support beams 42 can also provide multiple installation positions for the rail 3, enabling the rack 4 to flexibly configure different quantities and positions of the rail 3, meeting different storage needs.

Three or more groups of the shelf panels 43 for placing goods are also arranged between the support columns 41. The rails 3 are mounted to the support beams 42, and the rail 3 is further fixedly connected with telescoping mechanisms 31 for controlling forward and backward telescoping movement of the rail 3. The telescoping mechanism 31 adopts hydraulic cylinders or linear modules. The telescoping mechanisms 31 are fixedly connected to the support beams 42. Designing the rail 3 to be mounted to the support beam 42 is mainly to utilize the strength and stability of the support beams 42 to support and fix the rail 3. The support beams 42, as the main load-bearing components of the rack 4, possess sufficient strength and stiffness to bear the weight of the rail 3 and the vertical column 1 as well as dynamic loads during movement. Meanwhile, arranging the rail 3 on the support beams 42 also facilitates the installation and maintenance of the rail 3, while the telescoping mechanism 31 fixedly connected to the rail 3 is for achieving flexible connection and goods transmission between the racks 4 or between the rack 4 and a conveyor belt. The telescoping mechanisms 31 drive the rail 3 and the vertical columns 1 mounted to the rail 3 to move together when the telescoping mechanisms 31 telescope. By controlling the telescoping movement of the telescoping mechanisms 31, the position and length of the rail 3 can be adjusted, enabling the vertical columns 1 and the loading platforms 2 to accurately reach designated access positions. This design not only improves the automation level and operational efficiency of the storage robot 100 but also increases the flexibility and adaptability of the rack 4, enabling more effective utilization of warehouse space.

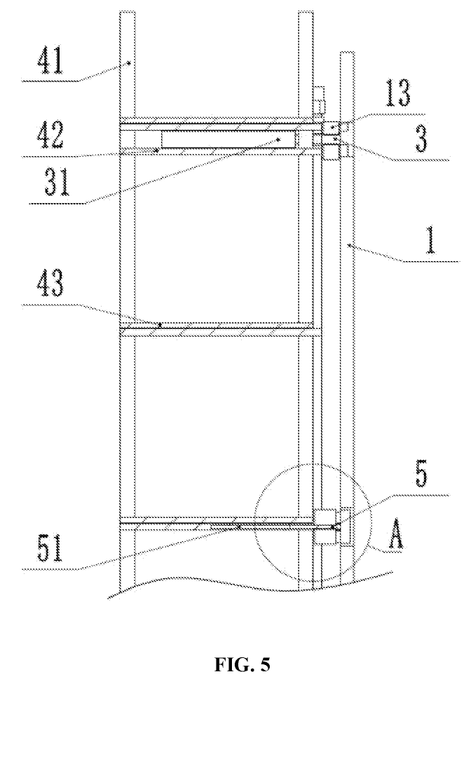

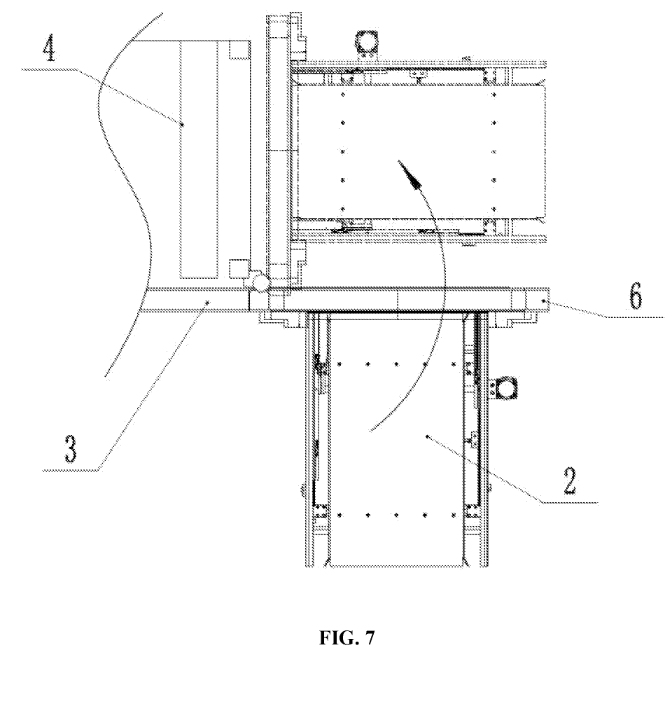

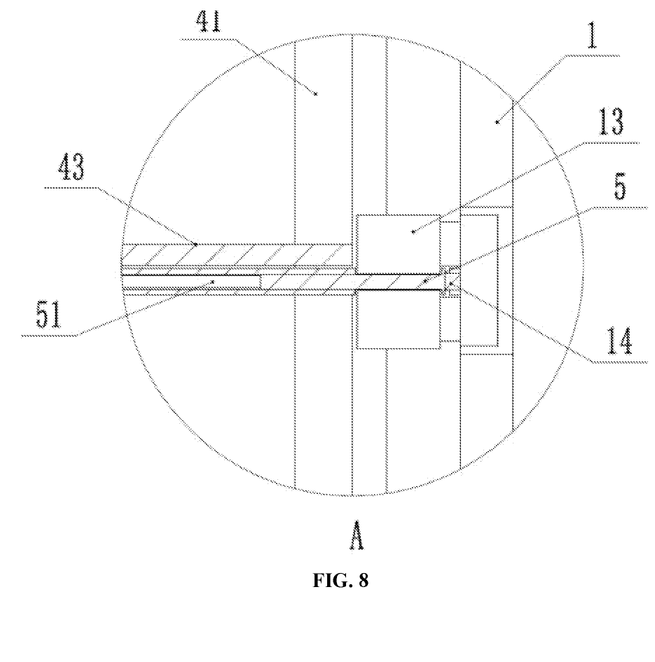

Please refer to FIG. 4, FIG. 5, FIG. 7, and FIG. 8, the shelf panel 43 is provided with shelves. In the embodiment, four or more groups of the telescoping mechanism 31 are provided. Designing four or more groups of the telescoping mechanisms 31 is mainly to ensure that the connection between the racks 4 or between the rack 4 and a conveyor belt is more stable and reliable. Multiple groups of the telescoping mechanisms 31 can distribute the load, reducing the force on a single telescoping mechanism 31, thereby extending its service life.

Between the rails 3 at the top and the bottom is arranged with an anti-sway push plate 5 for preventing the vertical column 1 from swaying during movement. Designing the anti-sway push plate 5 for preventing the vertical column 1 from swaying during movement to be arranged between the rails 3 at top and the bottom is mainly to enhance the stability and safety of the rack 4. The vertical column 1 may generate swaying during high-speed movement; this swaying not only affects the operational accuracy of the storage robot 100 but may also cause impact and wear to the rack 4 and the surrounding environment. The anti-sway push plate 5 can effectively absorb and disperse this swaying energy, thereby maintaining the stability of the vertical column 1 and ensuring that the storage robot 100 can precisely reach designated positions for storage and retrieval of goods.

Between the anti-sway push plate 5 and the vertical column 1 is provided with the driving wheel assembly 13. The anti-sway push plate 5 is slidably connected with the shelf panel 43. Designing the driving wheel assembly 13 to be arranged between the anti-sway push plate 5 and the vertical column 1 is mainly to facilitate rapid sliding of the vertical column 1 on the anti-sway push plate 5. The driving wheel assembly 13 can provide sufficient driving force and flexibility.

Moreover, between the shelf panel 43 and the anti-sway push plate 5 is provided with a pneumatic rod 51. The pneumatic rod 51 is mainly to provide additional support and buffering action. The pneumatic rod 51 can perform real-time adjustment according to the swaying degree of the vertical column 1, providing sufficient support force for the anti-sway push plate 5, thereby reducing the swaying amplitude of the vertical column 1. Simultaneously, the pneumatic rod 51 can also act as a damping element, providing buffering and damping action when the vertical column 1 sways; the anti-sway push plate 5 abuts, in a direction perpendicular to a sliding direction of the driving wheel assembly 13, against the driving wheel assembly 13.

Between the anti-sway push plate 5 and an abutting surface of the driving wheel assembly 13 is provided with a tensioning pulley 14. The tensioning pulley 14 is rotationally connected to the driving wheel assembly 13. Designing the tensioning pulley 14 to be arranged between the anti-sway push plate 5 and the abutting surface of the driving wheel assembly 13 is mainly to reduce the friction force and wear between the anti-sway push plate 5 and the driving wheel assembly 13. The tensioning pulley 14 can be rotationally connected to the driving wheel assembly 13, enabling the anti-sway push plate 5 to slide more smoothly during movement, reducing direct contact and friction with the driving wheel assembly 13.

Please refer to FIG. 4 and FIG. 7, the rail 3 at both sides of the rack 4 are provided with rotary guide rails 6. The rotary guide rails 6 are rotationally connected to the support columns 41. Designing the rail 3 at both sides of the rack 4 to be provided with the rotary guide rails 6, and the rotary guide rails 6 to be rotationally connected to support columns 41, is mainly to provide the function of flexible rotation for the vertical column 1 and the loading platform 2 between the racks 4 or between the rack 4 and conveyor belts. This design enables the storage robot 100 to conveniently change travel direction or turn to other racks 4 after completing storage and retrieval operations of goods, improving flexibility and operational efficiency of the storage robot 100.

The rotary guide rails 6 are vertically height-aligned with the rail 3. Designing the rotary guide rails 6 to be vertically height-aligned with the rail 3 is mainly to ensure that the vertical column 1 can smoothly transition onto the rotary guide rails 6 when moving along the rail 3, avoiding impact and instability caused by height differences. This alignment design enables the vertical column 1 to maintain a horizontal state during rotation, reducing swaying and friction, and improving rotational smoothness. An upper rotary guide rail 6 and a lower rotary guide rail 6 are fixedly connected by a connecting plate 61. The connecting plate 61 is to enhance the overall stability and strength of the rotary guide rails 6. The connecting plate 61 firmly connects the upper and lower rotary guide rails 6 together, forming a stable structure capable of bearing the weight of the vertical column 1 and the loading platform 2 as well as forces generated during rotation. Simultaneously, the connecting plate 61 also serves guiding and supporting roles, ensuring the vertical column 1 maintains correct position and direction during rotation.

The rotary guide rail 6 is provided with a rotation motor 62 for driving the rotary guide rail 6 to rotate. The rotation motor 62 is connected to the rotation shaft of the rotary guide rails 6 through a drive shaft, capable of driving the rotary guide rails 6 and the vertical column 1 to rotate together. This design enables the storage robot 100 to flexibly change travel direction or turn to other racks 4 as needed, improving automation level and operational efficiency of the robot; when the vertical column 1 moves onto the rotary guide rails 6 along the rail 3, the rotary guide rails 6 drive the vertical column 1 to rotate.

The rotary guide rails 6 is further fixedly connected with a rotation shaft. The rotation shaft connects the upper rotary guide rail 6 and the lower rotary guide rail 6. The rotation shaft is rotationally connected with the support column 41, and the rotation shaft is connected to a drive shaft of the rotation motor 62. The rotation shaft, as the central axis of rotation, can bear forces generated during rotation and maintain rotational stability. Simultaneously, the connection between the rotation shaft and the drive shaft of the rotation motor 62 enables the rotation motor 62 to precisely control the rotation speed and angle of the rotary guide rails 6, improving operational accuracy and reliability of the robot. The rotation motor 62 is fixedly installed on the support columns 41 of the rack 4. By installing the rotation motor 62 on the support columns 41 can fully utilize the structure and space of the rack 4, avoiding additional installation of brackets or fixing devices. Simultaneously, the support columns 41, as the main load-bearing structure of the rack 4, possess high stability and strength, capable of supporting the weight of the rotation motor 62 and forces generated during rotation.

An extension push plate 63 is further arranged between the upper rotary guide rail 6 and the lower rotary guide rail 6. The extension push plate 63 is fixedly installed on the connecting plate 61, and the extension push plate 63 is position-aligned with the anti-sway push plate 5. The extension push plate 63 is rotationally connected to the support columns 41. Designing the extension push plate 63 to be position-aligned with the anti-sway push plate 5 is mainly to ensure that the vertical column 1 can smoothly transition onto the extension push plate 63 when moving along the anti-sway push plate 5, avoiding impact and instability caused by height differences.

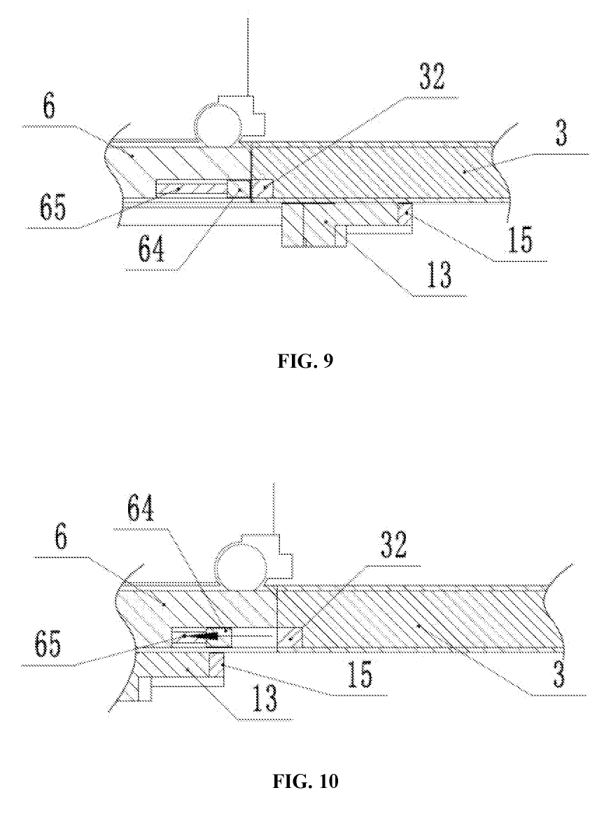

Please refer to FIG. 9 and FIG. 10, a slidable locking block 64 is further arranged inside the rotary guide rails 6. Designing the slidable locking block 64 inside the rotary guide rails 6 is mainly to increase equipment safety and stability. During storage robot operation, if the vertical column 1 accidentally rotates without reaching the predetermined position, it may cause goods damage, equipment failure, or even personnel casualties. The design of the locking block 64 ensures that when the vertical column 1 is not correctly positioned on the rotary guide rails 6, the rotary guide rails 6 will not accidentally rotate, thereby avoiding the aforementioned risks.

An elastic trigger structure 65 is arranged between the locking block 64 and the rotary guide rail 6. When the elastic trigger structure 65 is compressed, the rotation shaft releases locking; when elastic trigger structure 65 is not compressed, the rotation shaft locks. The elastic trigger structure 65 can provide unlocking/locking force for the rotation shaft and reset force for the locking block 64. The elastic trigger structure 65 adopts elastic elements such as springs or elastic sheets and is connected with a trigger component connected to the rotation shaft. The rail 3 opposite to the locking block 64 is provided with an adsorption block 32 that is capable of attracting the locking block 64. The adsorption block 32 is fixedly installed inside the rail 3. The design of the adsorption block 32 is to keep the locking block 64 in its original position through magnetic force generated between the adsorption block 32 and the locking block 64 when the locking block 64 is not unlocked, preventing accidental sliding due to vibration or external force. Simultaneously, the adsorption block 32 can also serve as a reset assist after the locking block 64 is unlocked, helping the locking block 64 quickly return to its original position after unlocking.

The driving wheel assembly 13 is provided with an unlocking block 15 that is capable of adsorbing the locking block 64 to slide inside the rotary guide rail 6. The unlocking block 15 and the locking block 64 adopt magnets with opposite magnetic poles. The adsorption block 32 adopts iron. Simultaneously, the attractive force generated between the unlocking block 15 and the locking block 64 is greater than the combined force of the adsorption block 32’s attractive force on the locking block 64 and the elastic force of the elastic trigger structure 65. The elastic trigger structure 65 is connected to the rotation shaft. Please refer to FIG. 10, when the elastic trigger structure 65 is compressed, the rotation shaft releases locking. Please refer to FIG. 9, when the elastic trigger structure 65 is not compressed, the rotation shaft is locked. This structure, through the elastic trigger structure 65, can effectively prevent accidental rotation when the vertical column 1 has not moved onto the rotary guide rails 6, thereby improving equipment safety, and the locking of the rotation shaft can prevent the robot from suddenly rotating due to misoperation or system failure, thereby avoiding harm to personnel or goods.

Working principle: During use of the present disclosure, the upper and lower driving wheel assemblies 13 installed on the vertical column 1 simultaneously drive the vertical column 1 to move at high speed along the rail 3 to a designated position on the rack 4. Then, the lifting device 11 controls the loading platform 2 to move to the goods position, and the clamping plate 22 is used for picking goods. Then, the above process is repeated to place goods on conveyor belts on both sides of the rack 4. The storage process is the reverse of the retrieval process. During movement, the driving wheel assemblies 13 arranged on the upper and lower rails 3, due to adopting synchronous servo drive, can effectively control the swing amplitude of the vertical column 1 during movement. Moreover, the design of the rail 3 on the rack 4 effectively reduces installation difficulty and installation cost, while also improving installation accuracy. During the goods retrieval process, the present invention adopts a dual loading platform 2 design. The dual loading platforms 2 can independently move up and down and retrieve goods, greatly improving retrieval efficiency.

In the present disclosure, during installation, one group of the storage robot 100 is installed between every two racks 4. When there are goods retrieval or storage requirements from one of the racks 4, the telescoping mechanism 31 pushes the rail 3 to move, making the vertical column 1 approach the rack 4 until the loading platform 2 reaches the distance where the clamping plate 22 can access goods. Then, goods retrieval/storage is performed on the rack 4. After completing goods retrieval/storage, the telescoping mechanism 31 retracts, bringing the vertical column 1 back to the initial position. This design can not only reduce the number of storage robot installations and lower costs but also effectively increase the usable space between the racks 4, thereby increasing the operational space between the racks 4, allowing some transport vehicles to pass between the racks 4, improving the overall operational efficiency of the warehouse.

In the present disclosure, during the process of placing/retrieving goods on conveyor belts, the placement/retrieval direction of the loading platform 2 can be changed through the rotary guide rails 6. After the vertical column 1 moves onto the rotary guide rails 6 along the rails 3 through the driving wheel assemblies 13, the rotation motor 62 drives the rotary guide rails 6 to rotate the vertical column 1 together to the conveyor belt position. Then, the loading platform 2 is controlled to move to the conveyor belt height, and the clamping plate 22 is used for placing/retrieving goods. Moreover, when the storage robot is in dormancy state, the driving wheel assembly 13 moves the vertical column 1 onto the rotary guide rails 6. Then, the rotary guide rails 6 rotate to one side of rack 4 perpendicular to the direction of the rail 3. In this state, the storage robot and its vertical column 1 structure no longer occupy the linear space between the racks 4, and the passage space of the warehouse becomes more spacious. Thus, not only are other operations in the warehouse facilitated, such as transport vehicles and personnel passage, but also the space within the warehouse can be utilized more effectively, improving the overall operational efficiency of the warehouse. And when the storage robot and its vertical column 1 rotate to one side of the rack 4 perpendicular to the direction of the rail 3 through the rotary guide rails 6, the center of gravity of the entire structure, including the vertical column 1, the loading platform 2, etc., changes relative to the position of the rack 4, but this change is relatively small. The rack 4 is more likely to remain stable during handling or movement, and accidental situations such as tipping are less likely to occur, greatly reducing handling difficulty and risk.

During the movement of the vertical column 1 along the rail 3, the anti-sway push plate 5 is always abutted against the driving wheel assembly 13. When the vertical column 1 generates swaying during high-speed movement, the anti-sway push plate 5 and the pneumatic rod 51 can effectively absorb vibrations. The anti-sway push plate 5 is tightly attached to the driving wheel assembly 13 through the tensioning pulley 14, while the pneumatic rod 51 acts as a damping element, providing buffering and damping effects when the vertical column 1 sways, thereby absorbing and dispersing vibration energy. Thus, swaying of the vertical column 1 during movement along the rail 3 is avoided, improving the stability of robot operation, ensuring that the loading platform 2 can accurately reach designated positions for goods access, simultaneously reducing impact and wear on the rack 4 and the surrounding environment during operation, extending the service life of equipment and the rack 4, and also reducing noise.

It should be noted that in this document, relational terms such as “first” and “second” are only used to distinguish one entity or operation from another entity or operation, and do not necessarily require or imply any actual such relationship or order between these entities or operations. Moreover, the terms “comprise”, “include” or any other variation thereof are intended to cover non-exclusive inclusion, so that a process, method, article or device that includes a series of elements not only includes those elements but also includes other elements not explicitly listed, or also includes elements inherent to such process, method, article or device. Without more restrictions, the element defined by the phrase “comprising a...” does not exclude the existence of additional identical elements in the process, method, article or device that includes the element.

Although embodiments of the present disclosure have been shown and described, those of ordinary skill in the art can understand that various changes, modifications, replacements and variations can be made to these embodiments without departing from the principles and spirit of the present disclosure. The scope of the present disclosure is defined by the appended claims and their equivalents.

What is claimed is:

1. A high-speed rack-mounted storage robot, comprising vertical columns (1), loading platforms (2), and a lifting device (11); the loading platform (2) being slidably mounted on the vertical column (1), and the loading platform (2) being arranged along a vertical direction of the vertical column (1); a bottom of the vertical column (1) is fixedly installed with the lifting device (11) that drives the loading platform (2) to move vertically; wherein,
two or more groups of the loading platforms (2) are provided; a top and a bottom of the vertical column (1) are both provided with a rail (3); the vertical column (1) is fixedly installed with two or more groups of driving wheel assemblies (13) that drive the vertical column (1) to slide along the rails (3); the driving wheel assembly (13) is slidably connected to the rail (3); the rail (3) is fixedly connected to a rack (4), wherein a length of the rails (3) is longer than a length of the rack (4);
the rack (4) comprises support columns (41), support beams (42) and shelf panels (43); wherein a plurality of the support columns (41) are arranged vertically at equal intervals; two or more of the support beams (42) are fixedly connected between the support columns (41); three or more groups of the shelf panels (43) for placing goods are arranged between the support columns (41); the rails (3) are mounted to the support beams (42), and the rails (3) are further fixedly connected with telescoping mechanisms (31) for controlling forward and backward telescoping movement of the rails (3); wherein the telescoping mechanisms (31) are fixedly connected to the support beams (42); the telescoping mechanisms (31) drive the rail (3) and the vertical columns (1) mounted to the rail (3) to move together when the telescoping mechanisms (31) telescope;
the rails (3) at both sides of the rack (4) are provided with rotary guide rails (6); wherein the rotary guide rails (6) are rotatably connected to the support columns (41); the rotary guide rails (6) are vertically height-aligned with the rails (3), and an upper rotary guide rail (6) and a lower rotary guide rail (6) are fixedly connected by a connecting plate (61); and the rotary guide rail (6) is provided with a rotating motor (62) that drives the rotary guide rail (6) to rotate; when the vertical column (1) moves to the rotary guide rail (6) along the rails (3) by the driving wheel assemblies (13), the rotary guide rail (6) drives the vertical column (1) to rotate;
the rotary guide rail (6) is further fixedly connected with a rotating shaft, wherein the rotating shaft connects the upper rotary guide rail (6) and the lower rotary guide rail (6); the rotating shaft is rotatably connected with the support column (41), and the rotating shaft is connected to a drive shaft of the rotating motor (62); the rotating motor (62) is fixedly installed on the support column (41) of the rack (4); an extension push plate (63) is arranged between the upper rotary guide rail (6) and the lower rotary guide rail (6); wherein the extension push plate (63) is fixedly installed on the connecting plate (61), and the extension push plate (63) is position-aligned with an anti-sway push plate (5); the extension push plate (63) is rotatably connected to the support columns (41); a slidable locking block (64) is further arranged inside the rotary guide rail (6), an elastic trigger structure (65) is arranged between the locking block (64) and the rotary guide rail (6), and the rail (3) opposite to the locking block (64) is provided with an adsorption block (32) that is capable of attracting the locking block (64); the adsorption block (32) is fixedly installed inside the rail (3); the driving wheel assembly (13) is provided with an unlocking block (15) that is capable of attracting the locking block (64) to slide inside the rotary guide rail (6); the unlocking block (15) and the locking block (64) adopt magnets with opposite magnetic poles, and the adsorption block (32) adopts iron; the elastic trigger structure (65) is connected with the rotating shaft; when the elastic trigger structure (65) is compressed, the rotating shaft releases locking, and when the elastic trigger structure (65) is not compressed, the rotating shaft is locked.

2. The high-speed rack-mounted storage robot according to claim 1, wherein both ends of the loading platform (2) are provided with a transmission structure (21); wherein between the transmission structure (21) and the lifting device (11) is provided with a transmission chain; the lifting devices (11) at both ends of the vertical column (1) respectively drive two groups of the loading platforms (2) to move up and down independently.

3. The high-speed rack-mounted storage robot according to claim 1, wherein the loading platform (2) is placed with goods, and the loading platform (2) is provided with clamping plates (22) that are capable of moving along a horizontal direction of the loading platform (2) to load and unload goods.

4. The high-speed rack-mounted storage robot according to claim 1, wherein two or more of the vertical columns (1) are provided, and between the two or more vertical columns (1) is provided with a crossbeam (12).

5. The high-speed rack-mounted storage robot according to claim 1, wherein four or more groups of the telescoping mechanisms (31) are provided; the anti-sway push plate (5) for preventing the vertical column (1) from swaying during movement is arranged between the rails (3) at the top and the bottom; between the anti-sway push plate (5) and the vertical column (1) is provided with the driving wheel assembly (13); the anti-sway push plate (5) is slidably connected with the shelf panel (43), and between the shelf panel (43) and the anti-sway push plate (5) is provided with a pneumatic rod (51); the anti-sway push plate (5) abuts, in a direction perpendicular to a sliding direction of the driving wheel assembly (13), against the driving wheel assembly (13).

6. The high-speed rack-mounted storage robot according to claim 5, wherein between the anti-sway push plate (5) and an abutting surface of the driving wheel assembly (13) is provided with a tensioning pulley (14); wherein the tensioning pulley (14) is rotatably connected to the driving wheel assembly (13).
